(19) United States
(12) Patent Application Publication
(10) Pub. No.: US 2022/0297522 A1
(43) Pub. Date: Sep. 22, 2022

(54) A BATTERY MOUNTING ARRANGEMENT AND A VEHICLE

(71) Applicant: JAGUAR LAND ROVER LIMITED, Warwickshire (GB)

(72) Inventor: Stephen NICHOLLS, Warwickshire (GB)

(21) Appl. No.: 17/626,454

(22) PCT Filed: Jul. 13, 2020
(86) PCT No.: PCT/EP2020/069740

§ 371 Date: Jan. 11, 2022

(30) Foreign Application Priority Data
Jul. 12, 2019 (GB) 1910001.5

(51) Int. Cl. B60K 1/04; B60L 50/60; B60L 58/26

(52) U.S. Cl. CPC B60K 1/04; B60L 50/66; B60L 58/26; B60K 2001/0438; B62D 21/157

(57) ABSTRACT

Aspects of the present disclosure relate to a battery mounting arrangement for a vehicle and to a vehicle. The battery mounting arrangement comprises a first supporting structure, a second supporting structure and at least one battery cell container. The at least one battery cell container is supported by both the first supporting structure and the second supporting structure, and the at least one battery cell container has a first end face facing the first supporting structure and a second end face facing the second supporting structure. The stiffness of the at least one battery cell container compared to the stiffness of the second supporting structure is sufficiently large to enable the second supporting structure to be deformed under a force provided by the at least one battery cell container due to a force applied to the first end face of the at least one battery cell container.

### TECHNICAL FIELD

The present disclosure relates to a battery mounting arrangement and a vehicle. In particular, but not exclusively it relates to battery mounting arrangement for a road vehicle, such as a car, and to such a vehicle.

### BACKGROUND

Road vehicles are designed to protect their occupants in the event of a crash. To protect the occupants a vehicle provides a barrier to intrusion by objects impacting against the vehicle. In addition, to protect the occupants from the most extreme accelerations of their vehicle that might occur during a crash, vehicles have outer parts, which may be referred to as crumple zones, that are designed to crumple during a collision to dissipate energy. For example, the side sills of a car may be designed to deform during a side impact caused by the car sliding sideways into a post. Similarly, beams at the front end or rear end of the car may be designed to crumple, for example, in the event of the car running into an object, such as another vehicle, or the car being hit from behind by another vehicle.

The batteries of battery electric vehicles are designed such that they occupy a relatively large volume in the vehicle in order to provide as much electrical storage as possible. However, for safety reasons, the batteries are also protected by generally not being positioned within parts of a vehicle designated as crumple zones. Consequently, the space available for locating batteries is limited, and so the storage capacity is also limited.

In addition, it is known to design battery electric vehicles with very strong floors in order to provide the required support and protection for batteries mounted to the floors. A problem with this is that the body of such an electric vehicle is then unsuitable for use when manufacturing an energy efficient vehicle powered by an internal combustion engine, because a vehicle powered by an internal combustion engine may be produced with a much lighter floor panel. If a manufacturer wishes to produce both battery electric vehicles and vehicles powered by internal combustion engines, it is therefore generally necessary for the manufacturer to create vehicle bodies that are specific to each of those vehicle types.

It is an aim of the present disclosure to address one or more of the disadvantages associated with the prior art.

### SUMMARY

Aspects and embodiments of the disclosure provide a battery mounting arrangement for a vehicle, and a vehicle.

According to an aspect of the disclosure there is provided a battery mounting arrangement for a vehicle comprising: a first supporting structure; a second supporting structure; and at least one battery cell container supported by both the first supporting structure and the second supporting structure, and the at least one battery cell container having a first end facing the first supporting structure and a second end facing the second supporting structure; wherein stiffness of the at least one battery cell container compared to the stiffness of the second supporting structure is sufficiently large to enable the second supporting structure to be deformed under a force provided by the at least one battery cell container due to a force applied to the first end of the at least one battery cell container.

If the battery mounting arrangement is used in a vehicle, the battery cell container provides protection for battery cells located within it, in the event of a collision in which a force is applied to the first end face. This enables the first end face to be located within a crumple zone of the vehicle, and so the spatial volume of the battery and its electrical storage capacity may be larger than they otherwise could be. In addition, because the battery mounting arrangement provides the required protection to the battery cells, it may be used to produce a battery electric vehicle from a vehicle body designed for use in a vehicle powered by an internal combustion engine.

Optionally, the first supporting structure extends in a first direction, the second supporting structure extends substantially parallel to the first supporting structure, and the at least one battery cell container extends in a direction from its first end to its second end in a second direction substantially perpendicular to the first direction. The battery cell container may be mounted from structures such as beams that are present in the body of the vehicle.

Optionally, the first direction is along the length of the vehicle. The first end face of the battery cell container may be positioned within a crumple zone towards the front end of the vehicle, such as in a compartment occupied by the electric motor of the vehicle, or it may be located within a crumple zone towards the rear end of the vehicle, such as in or under the boot (i.e. trunk).

Optionally, the first direction is laterally across the width of the vehicle. The first end face of the battery cell container may be positioned within a crumple zone at a left side or a right side of the vehicle.

Optionally, the stiffness of the at least one battery cell container compared to the stiffness of the first supporting structure is sufficient to enable the first supporting structure to be deformed by compression between an applied force and a reaction force provided by the at least one battery cell container. The battery cell container may assist in providing a required reaction force to maintain the general position of the first support structure during a time when it crumples during a collision, without the battery cell container being deformed itself and damaging battery cells it contains.

Optionally, stiffness of the at least one battery cell container compared to the stiffness of the first supporting structure is sufficiently large to enable the first supporting structure to be deformed under a force provided by the at least one battery cell container due to a force applied to the second end of the at least one battery cell container. In some embodiments, if the battery mounting arrangement is used in a vehicle, the battery cell container provides protection for battery cells located within it, in the event of a collision in which a force is applied to the second end face. This enables the second end face to be located within a crumple zone of the vehicle, and so the spatial volume of the battery and its electrical storage capacity may be larger than they otherwise could be. For example, in embodiments in which the battery cell container extends between support structures comprising sills of the vehicle, the battery may have a width across the vehicle that is wider than it otherwise could be.

Optionally, the stiffness of the at least one battery cell container compared to the stiffness of the second supporting structure is sufficient to enable the second supporting structure to be deformed by compression between an applied force and a reaction force provided by the at least one battery cell container. The battery cell container may assist in providing a required reaction force to maintain the general position of the second support structure during a time when it crumples during a collision, without the battery cell container being deformed itself and damaging battery cells it contains.

Optionally, the first supporting structure comprises a first beam of the vehicle.

Optionally, the battery mounting arrangement comprises a support plate supported by the first beam; the at least one battery cell container is mounted to the support plate; and a first portion of the support plate forms a part of the first supporting structure.

Optionally, the second supporting structure comprises a second beam of the vehicle.

Optionally, the support plate is supported by the second beam, and a second portion of the support plate forms a part of the second supporting structure.

Optionally, the at least one battery cell container has a length, a height and a width; the length is longer than the height and the width; and the length is aligned laterally across the vehicle.

Optionally, the at least one battery cell container contains a plurality of cells forming at least a part of a battery.

Optionally, the at least one battery cell container comprises a tube. The battery cell container is strong in compression along its length.

Optionally, the tube has a rectangular cross-section. A plurality of battery cell containers may be positioned alongside one another to form a compact unit.

Optionally, the tube comprises a battery cooling pipe and/or an electrical conductor that extends from the first end and/or the second end of the tube. The side walls of the tube may be continuous and therefore the strength of the tube under compression along its length is not compromised.

Optionally, the battery mounting arrangement comprises a connecting member; a lower surface of each said battery cell container is attached to the support plate; and an upper surface of each said battery cell container is fixed to the connecting member, which is configured to resist separation of each said battery cell container from a neighboring battery cell container. The unit formed by the battery cell containers is provided with greater rigidity.

According to another aspect of the disclosure there is provided a vehicle comprising the battery mounting arrangement of any one of the previous paragraphs, wherein the vehicle comprises an electric motor powered by battery cells located within the at least one battery cell container.

Optionally, the vehicle comprises a cabin for receiving users of the vehicle and the cabin has a floor defining a tunnel extending along the middle of the floor in a direction from front to rear of the vehicle. The body of the vehicle may be one that is already used to produce a vehicle powered by an internal combustion engine rather than the electric motor, and therefore the cost in establishing production of a battery electric vehicle may be much reduced.

According to a further aspect of the disclosure there is provided a battery mounting arrangement for a vehicle comprising: a first supporting structure extending along the vehicle; a second supporting structure extending along the vehicle; and at least one tube for containing battery cells, wherein each said tube has a first end adjacent to, and supported by, the first supporting structure and a second end adjacent to, and supported by the second supporting structure, and the at least one tube has an axial stiffness greater than a lateral stiffness of each of the first supporting structure and the second supporting structure. If the battery mounting arrangement is used in a vehicle, the tube provides protection for battery cells located within it, in the event of a collision in which a force is applied to the first end. This enables the first end to be located within a crumple zone of the vehicle, and so the spatial volume of the battery and its electrical storage capacity may be larger than they otherwise could be. In addition, because the battery mounting arrangement provides the required protection to the battery cells, it may be used to produce a battery electric vehicle from a vehicle body designed for use in a vehicle powered by an internal combustion engine.

According to yet another aspect of the disclosure there is provided a battery mounting arrangement for a vehicle comprising: a first supporting structure extending along the vehicle; a second supporting structure extending along the vehicle; and a plurality of tubes aligned laterally across the vehicle, each said tube having a first end adjacent to, and supported by, the first supporting structure and a second end adjacent to, and supported by, the second supporting structure; and a plurality of battery cells located in each one of the tubes. If the battery mounting arrangement is used in a vehicle, the tube provides protection for battery cells located within it, in the event of a collision in which a force is applied to the first end. This enables the first end to be located within a crumple zone of the vehicle, and so the spatial volume of the battery and its electrical storage capacity may be larger than they otherwise could be. In addition, because the battery mounting arrangement provides the required protection to the battery cells, it may be used to produce a battery electric vehicle from a vehicle body designed for use in a vehicle powered by an internal combustion engine.

Within the scope of this application it is expressly intended that the various aspects, embodiments, examples and alternatives set out in the preceding paragraphs, in the following description and drawings, and the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE FIGURES

One or more embodiments of the disclosure will now be described, by way of example only, with reference to the accompanying drawings, in which:

FIG. 1 shows a schematic diagram of a battery electric vehicle comprising a battery mounting arrangement embodying the present disclosure;

FIG. 2 shows the battery mounting arrangement of FIG. 1 during a collision with a post 201;

FIG. 3 shows the battery mounting arrangement of FIG. 1 after a collision with a post 201;

FIG. 4 shows a side view of a vehicle embodying the present disclosure;

FIG. 5 shows a plan view of the vehicle of FIG. 4;

FIG. 6 shows a perspective view of a portion of the battery on its support plate;

FIG. 7 shows a cross-sectional view of the vehicle of FIG. 4;

FIG. 8 shows a cross-sectional view of the vehicle of FIG. 4 after a side-on collision with a post;

FIG. 9 shows a plan view of the vehicle of FIG. 4 after the side-on collision with the post;

FIG. 10 shows a plan view of another battery electric vehicle embodying the present disclosure is shown under the floor of the rear luggage compartment

FIG. 11 shows a side view of the vehicle of FIG. 10; and

FIG. 12 shows a plan view of a further alternative vehicle embodying the present disclosure.

### DETAILED DESCRIPTION

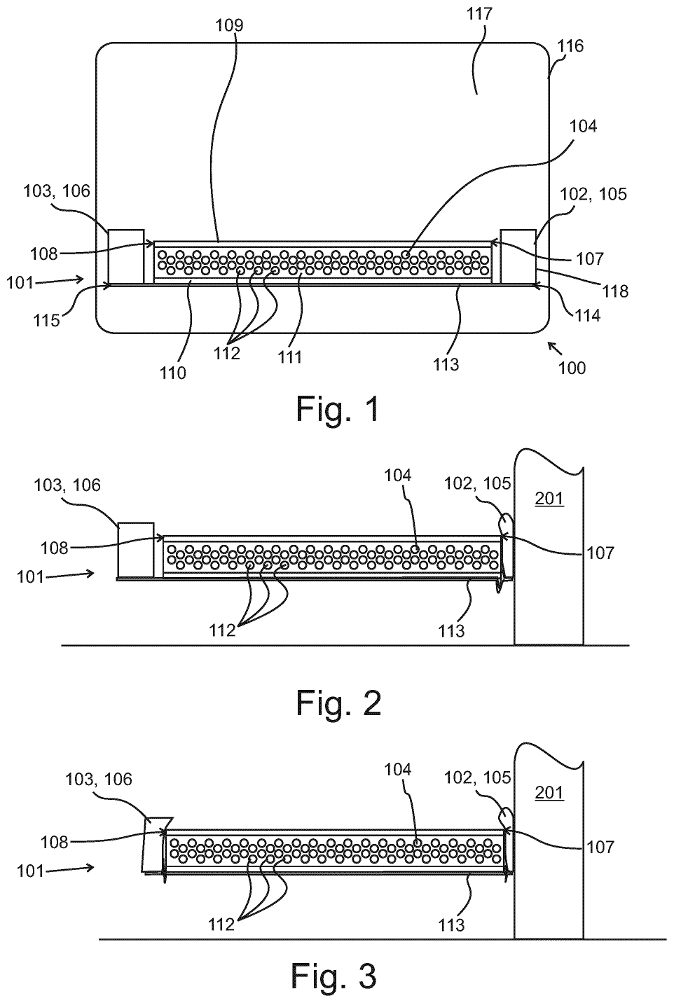

A battery mounting arrangement 101 for a vehicle, and a vehicle 100 comprising a battery mounting arrangement 101 in accordance with an embodiment of the present disclosure, is described herein with reference to the accompanying FIGS. 1 to 3.

With reference to FIG. 1, the battery mounting arrangement 101 comprises a first supporting structure 102, a second supporting structure 103, and a battery cell container 104 supported by both the first supporting structure 102 and the second supporting structure 103.

The first supporting structure 102 comprises a first beam 105 (extending into the page in FIG. 1) that forms a part of the body 116 of the vehicle 100 and similarly the second supporting structure 103 comprises a second beam 106 (also extending into the page in FIG. 1) that forms a part of the body 116 of the vehicle 100.

The battery cell container 104 has a first end face 107 that faces the first beam 105 and a second end face 108 that faces the second beam 106. The battery cell container 104 is in the form of a tube having outer walls, such as outer walls 109 and 110, that define a volume 111 for containing battery cells 112.

In the present embodiment, the battery cell container 104 is mounted on a support plate 113 that is attached to the first beam 105 at, or adjacent to, a first edge 114 of the support plate 113. The support plate 113 is also attached to the second beam 106 at, or adjacent to, a second edge 115 of the support plate 113. The battery cell container 104 is attached to the support plate 113 at, or adjacent to, each of its end faces 107 and 108. The battery cell container 104 extends in a direction from the first beam 105 to the second beam 106. In the present embodiment, the battery cell container 104 is shorter than the distance between the two beams 105 and 106, so that a gap exists between each of the beams 105 and 106 and the end face 107, 108 that faces the beam. A portion of the support plate 113 connecting the first beam 105 and the battery cell container 104 therefore provides a part of the first support structure 102, and similarly a portion of the support plate 113 connecting the second beam 106 and the battery cell container 104 provides a part of the second support structure 103.

In the present embodiment the support plate 113 extends across the whole length of the battery cell containers 104 but in alternative embodiments a first support plate 113 may support one end of the battery cell container 104 and a second support plate 113 may support its opposite end.

In embodiments illustrated in the present specification, the battery cell container 104 is mounted in a relatively low position within the vehicle 100, such as below a floor panel (not shown in FIG. 1) and the battery cell container 104 is mounted above the support plate 113. However, in alternative embodiments the battery cell container 104 may be mounted in a relatively high position within the vehicle 100 and/or below the support plate 113.

The body 116 of the vehicle 100 defines a space 117 configured to receive one or more people and/or cargo to enable transportation by the vehicle 100. The supporting structures 102 and 103 form parts of a rigid frame 118 that supports other parts of the body 116 of the vehicle 100 and also provides protection to people and/or cargo carried by the vehicle 100. The supporting structures 102 and 103 are configured to resist intrusion into the space 117 when the vehicle 100 collides with another object, in order to provide protection to the users of the vehicle 100 and/or its cargo. However, in order to reduce the magnitude of sudden increases in acceleration that the users and/or cargo are subjected to during such a collision, the support structures 102 and 103 are configured to crumple. Thus, much of the energy of the vehicle 100 and/or the object with which it collides is used to deform one or both of the support structures 102 and 103.

For example, as shown in FIG. 2, the first support structure 102 is shown in a deformed state during an impact of the vehicle 100 against a post 201. A portion of the support plate 113 between the first beam 105 and the battery cell container 104 has crumpled so that the beam 105 is pressed against the first end face 107 of the battery cell container 104. Under an applied force along its length, the battery cell container 104 is relatively stiff when compared to the lateral stiffness of the first beam 105. Consequently, the beam 105 has also begun to be squashed between the post 201 and the first end face 107 of the battery cell container 104. I.e.

the first supporting structure 102 has been deformed by compression between a force applied by the post 201 and a reaction force provided by the battery cell container 104.

As the collision progresses, the battery cell container 104 moves closer to the post 201 by further deformation of the first support structure 102. The post 201 then applies greater force to the first end face 107 of the battery cell container 104 via the first support structure 102. The battery cell container 104 is then pushed along its length towards the second beam 106, during which process a portion of the support plate 113 between the second end face 108 of the battery cell container 104 and the second beam 106 is crumpled. The battery cell container 104 is relatively stiff when compared to the lateral stiffness of the second beam 106, and consequently, the second beam 106 becomes deformed under forces applied by the battery cell container 104, as illustrated in FIG. 3, rather than the battery cell container 104 itself becoming deformed. Thus, the battery cells 112 within the battery cell container 104 are kept intact during the collision.

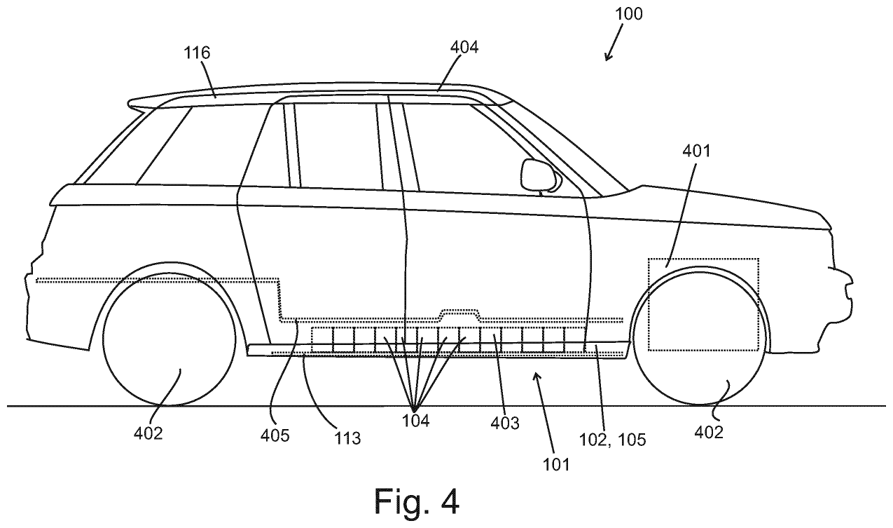

In at least some embodiments, such as that described below with reference to FIGS. 4 to 9, the battery mounting arrangement is substantially symmetrical and may comprise several battery cell containers 104. It should therefore be understood that in such embodiments the stiffness of the battery cell container(s) 104 compared to the stiffness of the first supporting structure 102 is sufficiently large to enable the first supporting structure 102 to be deformed under a force provided by the battery cell container(s) 104 due to a force applied to the second end face 108 of the battery cell container(s) 104. Also, the second supporting structure 103 is configured to deform by compression between a force applied to the second supporting structure 103 (for example by a post 201) and a reaction force provided by the second end face 108 of the battery cell container(s) 104.

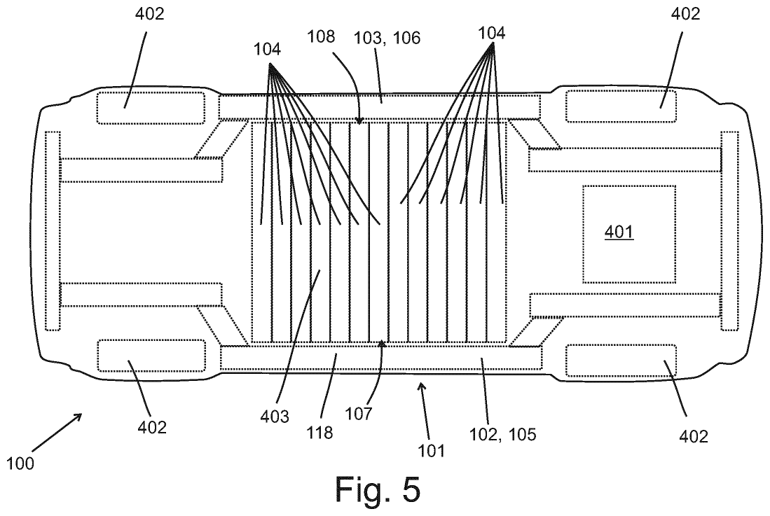

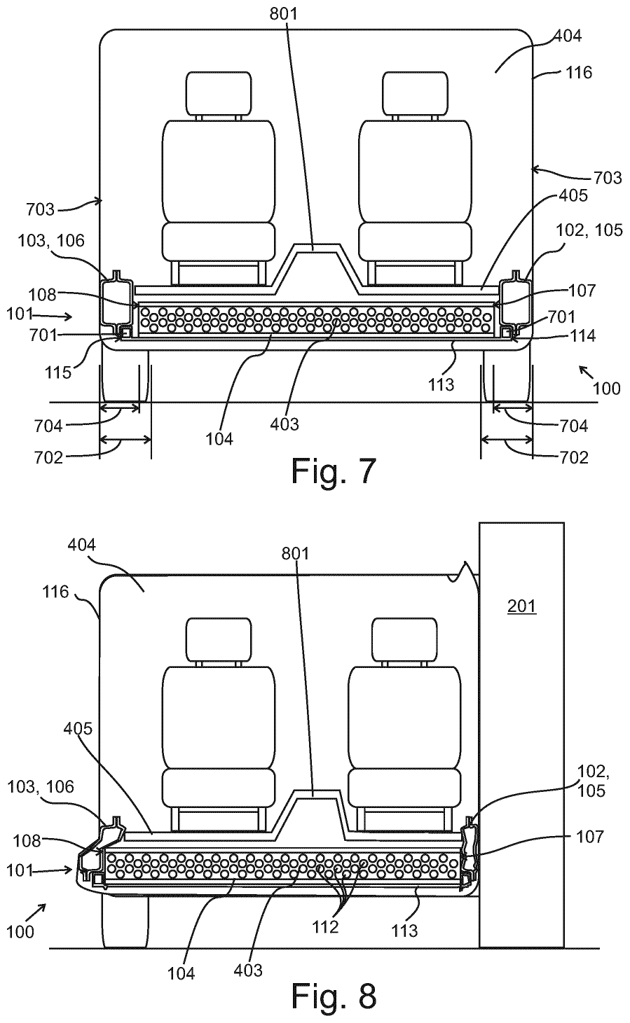

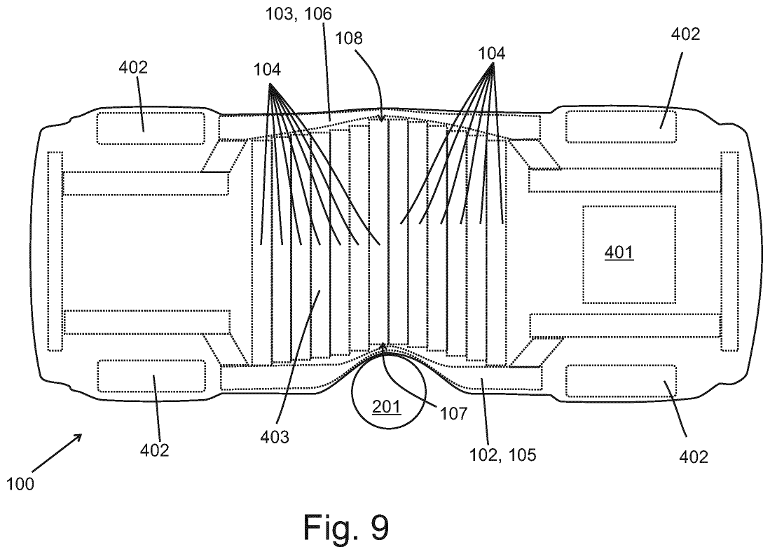

A vehicle 100 embodying the present disclosure is shown in a side view in FIG. 4, a plan view in FIG. 5 and a cross-sectional view in FIG. 7. The vehicle 100 is also shown after a collision with a post 201 in a cross-sectional rear view in FIG. 8 and a plan view in FIG. 9. Many of the features of the vehicle 100 of FIGS. 4, 5, 7, 8 and 9 are in common with those of the vehicle 100 of FIG. 1 and where appropriate they have been provided with similar references.

In the present embodiment the vehicle 100 is a car 100 but in alternative embodiments, the vehicle 100 may be another type of road vehicle 100 such as a van or a bus. The car 100 has an electric motor 401 (shown in FIGS. 4 and 5) positioned towards the front end of the car. The motor 401 provides torque to road wheels 402. In the present embodiment, the car 100 is a front wheel drive vehicle but in alternative embodiments the vehicle is a rear wheel drive vehicle. In other alternative embodiments, the vehicle 100 is a four-wheel drive vehicle and a second electric motor may be integrated with a rear axle of the vehicle to provide torque to the rear wheels 402.

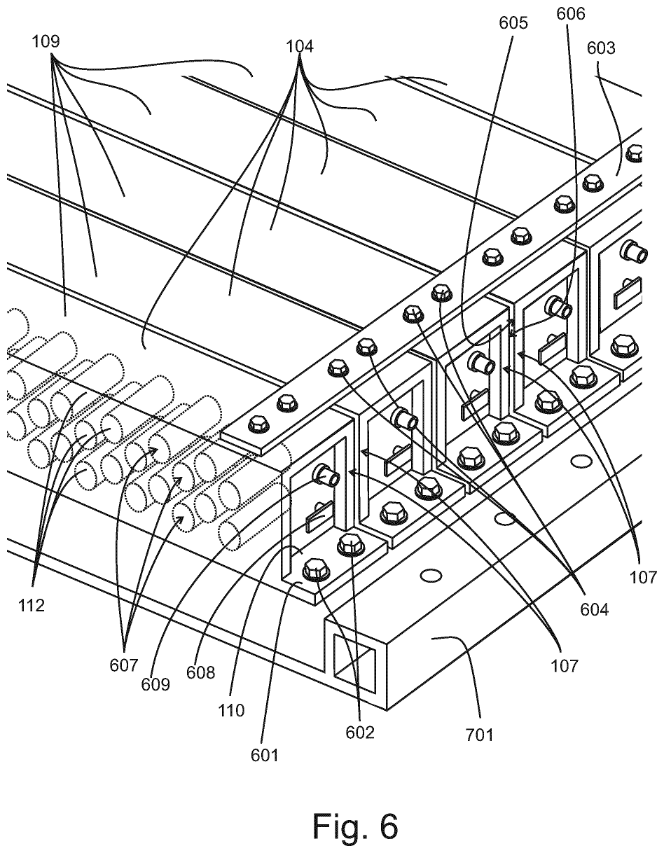

The body 116 of the car 100 includes a cabin 404 for receiving the driver and/or the passengers of the vehicle 100, and the cabin 404 has a floor panel 405. To provide the necessary power to the motor 401, the car 100 comprises an electric battery 403 that is located below the floor panel 405. The battery 403 comprises many electric battery cells (112 shown in FIGS. 6 and 7) that are electrically connected to provide electrical power to the motor 401. The battery cells are divided into a plurality of different sets and each of the sets is located in a respective one of a plurality of battery cell containers 104. In the example illustrated by FIGS. 4 and 5, the vehicle 100 has 13 battery cell containers 104 each containing a set of the battery cells forming the battery 403. Each of the battery cell containers 104 is in the form of a tube having a rectangular cross-section as illustrated in FIG. 4, and is mounted on a support plate 113 that extends across the bottom of the body 116 of the car 100. Each of the battery cell containers 104 extends laterally across the width of the car 100 in a direction from a first support structure 102, comprising a first beam 105, to a second support structure 103, comprising a second beam 106. In the present embodiment, the first beam 105 is in the form of a first sill 105 that extends along the right side of the car 100 and the second beam 106 is in the form of a second sill 106 that extends along the left side of the car 100.

The support plate 113 is fixed to each of the two sills 105 and 106 by a plurality of bolts (not shown). In the present embodiment, the support plate 113 is provided with a box-section 701 alongside each of its opposing edges 114 and 115 and the box-sections 701 are bolted to the sills 105 and 106.

It may be noted that the sills 105 and 106 of the vehicle 100 of FIG. 7 are designed to crumple in the event of a side impact on the vehicle 100 but also to resist penetration into the cabin 404 in order to provide safety to the occupants of the cabin. Specifically, the sills 105 and 106 are designed to prevent a standard sized post (201 in FIGS. 8 and 9) penetrating more than a specified first distance 702 (shown in FIG. 7) from the outside surface 703 of the vehicle 100 when the side of the vehicle collides with the post 201 at a specified speed. The battery 403 extends laterally across the vehicle 100 up to a second distance 704 from the outside surface 703 that is smaller than the first distance 702. However, due to the nature of the battery mounting arrangement 101, the battery cells 112 are protected from damage during a side impact in which a post penetrates by the first distance 702 into the cabin 404. By enabling the battery 403 to extend closer to the outside surface 703 of the vehicle 100, the battery mounting arrangement 101 allows the battery 403 is able to have a greater storage capacity than it otherwise would have.

A perspective view of a portion of the battery 403 on its support plate 113 is shown in FIG. 6. In this figure, portions of several of the battery cell containers 104 including their first end faces 107 are shown. It may be noted that, in the present embodiment, the battery cell containers 104 are substantially symmetrical so that the portions of the battery cell containers 104 that include their second end faces 108 are substantially the same as the portions shown in FIG. 6.

The battery cell containers 104 each include an attachment part 601 configured to enable attachment of the battery cell container 104 to the support plate 113. In the present embodiment, the attachment parts 601 are an extension of the lower wall 110 of the tubes 104 that are provided with holes (not shown) to enable the battery cell containers 104 to be fixed to the support plate 113 by bolts 602. Each of the battery cell containers 104 has a length, that is longer than its height and its width, and the length is aligned laterally across the vehicle 100.

Conductors 608 that are electrically connected to the battery cells 112 extend from the ends of the tubes 104 to enable connection to the motor 401. The tubes 104 may also be provided with cooling pipes 609 which extend from the ends of the tubes 104 to enable connection to a cooling-fluid circuit.

A connecting member 603 extends perpendicularly to the lengths of the battery cell containers 104 and is fixed to each the upper walls 109 of the battery cell containers 104 by bolts 604. The connecting member 603 shown in FIG. 6 is positioned near to the first end faces 107 of the battery cell containers 104, and a second connecting member (not shown), similar to the connecting member 603, is similarly positioned near to the second end faces 108.

The connecting member 603 prevents the upper wall 109 of each battery cell container 104 separating from the upper wall 109 of its neighbouring battery cell container(s) 104 in the event of the vehicle 100 having a collision that deforms the support plate 113. I.e. sidewalls of the battery cell containers 104, such as sidewalls 605 and 606, extend parallel to each other, and the connecting member 603 prevents a non-zero angle opening up between the sidewalls. This allows for assisting the distribution to neighbouring battery cell containers 104 of a force applied to an end face 107 or 108 of one of the battery cell containers 104 during a collision.

Positions of battery cells 112 are shown in FIG. 6 in one of the battery cell containers 104, but it should be understood that each of the battery cell containers 104 contains battery cells 112 in a similar manner In the present embodiment, the battery cells 112 have a cylindrical shape with a circular end face 607 that is in a plane parallel to the sidewalls of the battery cell containers 104, but in other embodiments, the orientation of the cells 112 may differ from this. In further embodiments the cells are prismatic or pouch cells in various orientations. As mentioned above, the battery cell containers 104 are in the form of a tube with a rectangular cross-section and, in an embodiment, the tube comprises two U-shaped channels welded together along their length.

The car 100 is shown after a side impact against a rigid post 201 in a rear cross-sectional view in FIG. 8 and a plan view in FIG. 9. In these figures, the floor panel 405 (shown in FIG. 8), the support plate 113 and the first sill 105 have crumpled. It may be noted that the post 201 impacts against the first sill 105 over a small portion of the length of the car 100 that corresponds to the width of just a few of the battery cell containers 104. However, due to the battery cell containers 104 being connected via the support plate 113 and the connecting member 603, the battery cell containers 104 are more easily able to provide a reactive force to enable the first sill 105 to be crumpled between the post 201 and the first end face 107 of the battery cell containers 104. After the collapse of the first sill 105, force applied by the post 201 to the battery cell containers 104 via the first sill 105 causes the battery cell containers 104 to be pushed along their length relative to the body 116 of the car 100. This movement of the battery cell containers 104 causes deformation of the second support structure 103. Specifically, it causes deformation of the portion of the support plate 113 between the second end face 108 of the battery cell containers 104 and the second sill 106, and it also causes deformation of the second sill 106. However, it may be noted that, because the battery cell containers 104 are all attached to the support plate 113, the force to the battery cell containers 104 is distributed to many of the battery cell containers 104, and not just the few that are directly impacted upon by the post 201.

Because the lateral stiffness of the second sill 106 is relatively small compared to the longitudinal stiffness of the battery cell containers 104, the battery cell containers 104 are able to be pushed sideways across the car 101 and remain intact as the second sill 106 deforms. Consequently, the battery cells 112 are undamaged by the collision.

In the present example, even though the car 100 is a battery electric vehicle, its body 116 is the same type as is used to produce vehicles comprising an internal combustion engine. As a consequence, the floor panel 405 has a form that includes a tunnel 801 (shown in FIGS. 7 and 8) to enable it to accommodate a transmission system for providing rear wheel drive and/or an exhaust system associated with an internal combustion engine. During the collision illustrated in FIG. 8, the tunnel 801 may become deformed. However, the battery 403 does not rely on the structural integrity of the floor panel 405 to protect it during the collision. Instead, the battery mounting arrangement 101, in which the battery cells 112 are located within tubes 104 extending between the sills 105 and 106, provides the required protection for the cells 112 of the battery 403. I.e. the battery mounting arrangement 101 allows a vehicle body 116 to be used for the manufacture of a battery electric vehicle that is not specifically designed for a battery electric vehicle.

In addition, because the floor panel 405 is not required to support and protect the battery 403, the floor panel 405 may be made with a relatively light mass, and this also allows the body 116 to remain usable for the production of an energy efficient car 100 with an internal combustion engine.

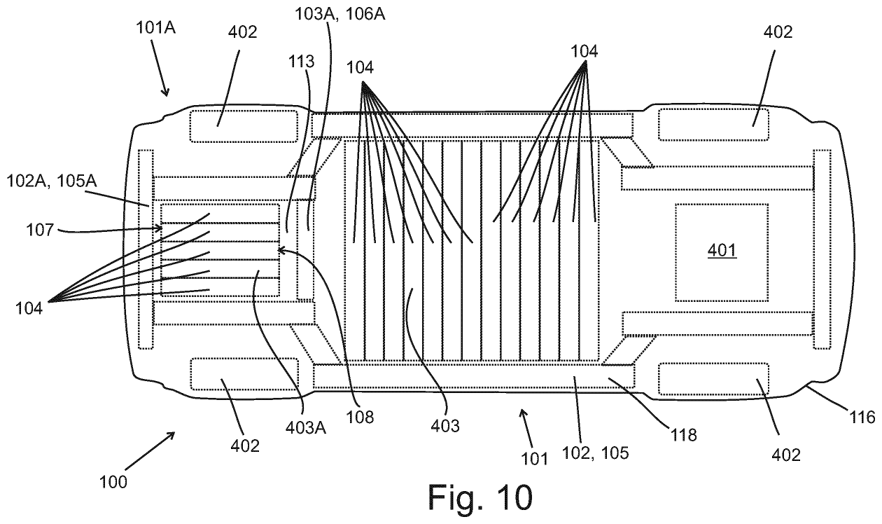

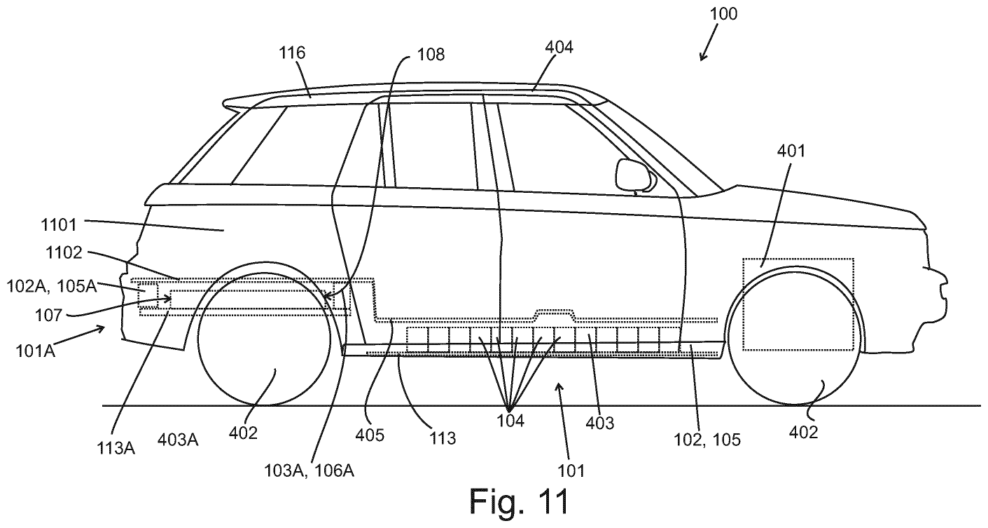

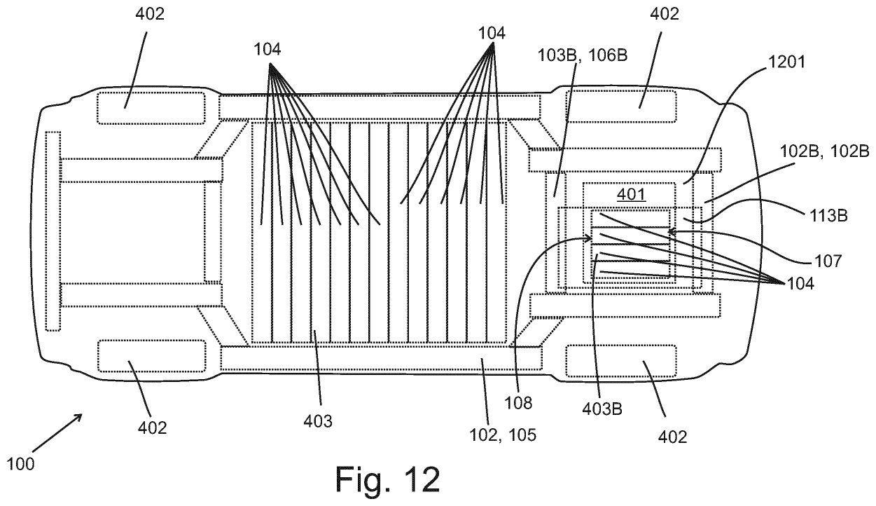

Another battery electric vehicle 100 embodying the present disclosure is shown in plan view in FIG. 10 and the side view of FIG. 11. Many of the features of the vehicle 100 of FIGS. 10 and 11 are in common with those of the vehicle 100 of FIG. 4 and they have been provided with similar references. Thus, for example, the vehicle 100 of FIGS. 10 and 11 comprises an electric motor 401 mounted within the body 116 of the vehicle 100 between the front road wheels 402. It also comprises a battery 403 which may have a form as described above with reference to FIGS. 4 to 9. However, in order to provide the vehicle 100 with further electrical storage capacity, it also comprises a second battery 403A located beneath the floor 1102 (shown in FIG. 11) of the boot 1101 of the vehicle 100, between its rear road wheels 402. The battery 403A has a similar construction to the battery 403, in that it comprises sets of battery cells (not shown), each set being located in one of a plurality of battery cell containers 104. In the present embodiment the battery 403A comprises 5 battery cell containers 104.

The battery cell containers 104 of the battery 403 are supported on a support plate 113A attached to a first support structure 102A comprising a first beam 105A and a second support structure 103A comprising a second beam 106A. The first beam 105A and the second beam 106A may form a part of the frame 118 of the vehicle 100.

The mounting arrangement 101A of the battery 403A differs from that of battery 403 in that the beams 105A and 106A extend laterally across the vehicle 100 and the battery cell containers 104 are in the form of tubes that extend in a direction along the length of the vehicle 100.

The first beam 105A extends across the rear end of the vehicle 100. In the event of an impact, for example when another vehicle hits the rear end of the vehicle 100 of FIG. 10, the first beam 105A and a portion of the support plate 113 between the first beam 105A and the battery cell containers 104 are deformed and pushed against the first ends 107 of the battery cell containers 104 of the battery 403A. The battery cell containers 104 are consequently pushed forward and their second end faces 108 press against the second beam 106A. The second beam 106A has a lateral stiffness that is small compared to the longitudinal stiffness of the battery cell containers 104 and therefore it is deformed instead of the battery cell containers 104 becoming deformed. Consequently, the battery cells contained by the battery cell containers 104 remain intact.

In this way the battery cells of the battery 403A may be located below the boot 1101 of the vehicle 100 at a position where the boot 1101 may be expected to be penetrated by the first beam 105A during an impact on the rear end of the vehicle 100. However, the battery mounting arrangement provides protection for the cells of the battery 403A by locating them in battery cell containers 104 having a first end face 107 facing the first supporting structure 102A and a second end face 108 facing the second supporting structure 103A, in which the stiffness of the battery cell containers 104 compared to the stiffness of the second supporting structure 103A is sufficiently large to enable the second supporting structure 103A to be deformed under a force provided by the battery cell containers 104 due to a force applied to the first end faces 107 of the battery cell containers 104.

A further alternative vehicle 100 embodying the present disclosure is shown in plan view in FIG. 12. Many of the features of the vehicle 100 of FIG. 12 are in common with those of the vehicle 100 of FIGS. 4, 5 and 7, and they have been provided with similar references. Thus, for example, the vehicle 100 of FIG. 12 comprises an electric motor 401 mounted within the body 116 of the vehicle 100 between the front road wheels 402 and within a compartment 1201. It also comprises a battery 403 which may have a form as described above with reference to FIGS. 4 to 9. However, in order to provide the vehicle 100 with further electrical storage capacity, it also comprises a second battery 403B located in the compartment 1201 containing the electric motor 401. In the present embodiment, the second battery 403B is located directly above the motor 401.

The battery 403B has a similar construction to the battery 403, in that it comprises sets of battery cells (not shown), each set being located in one of a plurality of battery cell containers 104. In the present embodiment the battery 403B comprises 4 battery cell containers 104.

Like those of the battery 403, the battery cell containers 104 of the battery 403B are supported at one end by a first support structure 102B comprising a first beam 105B and at a second end by a second support structure 103B comprising a second beam 106B, so that the first end face 107 faces the first beam 105B and the second end face 108 faces the second beam 106B. In the present embodiment, the first beam 105B extends laterally across the front end of the vehicle 100, the second beam 106B extends laterally across the vehicle 100 to the rear of the battery 403B, and the battery cell containers 104 are fixed to a support plate 113B that is supported by the two beams 105B and 106B.

The battery cell containers 104 are in the form of tubes that extend in a direction along the length of the vehicle 100 in a direction from the first beam 105B to the second beam 106B.

In the event of an impact on the front of the vehicle 100, for example when another vehicle collides with the front the vehicle 100 of FIG. 12, or the vehicle 100 hits a structure such as a post or a wall, the first beam 105B and a portion of the support plate 113B between the beam 105B and the battery cell containers 104 are deformed and push against the first ends 107 of the battery cell containers 104 of the battery 403B. The battery cell containers 104 are consequently pushed backwards and their second end faces 108 press against the second beam 106B. The second beam 106B has a lateral stiffness that is small compared to the longitudinal stiffness of the battery cell containers 104 and therefore it is deformed rather than the battery cell containers 104 becoming deformed. Consequently, the battery cells contained within the battery cell containers 104 remain intact.

In this way the battery cells of the battery 403B may be located in a compartment 1201 of the vehicle 100 containing its motor 401 at a position where the battery 403B may be subjected to an impact during a front-end collision of the vehicle 100. In such a collision, the battery mounting arrangement provides protection for the cells of the battery 403B by locating them in battery cell containers 104 having a first end face 107 facing the first supporting structure 102B and a second end face 108 facing the second supporting structure 103B, in which the stiffness of the battery cell containers 104 compared to the stiffness of the second supporting structure 103B is sufficiently large to enable the second supporting structure 103B to be deformed under a force applied by the battery cell containers 104 due to a force applied to the first end faces 107 of the battery cell containers 104.

In a further alternative embodiment, a vehicle 100 comprises the battery 403 located under the floor panel 403, as described with reference to FIGS. 4 to 9, the battery 403A located under the boot floor panel 1102, as described with reference to FIGS. 10 and 11 and the battery 403B located in a frontmost compartment 1201 of the vehicle 100, as described with reference to FIG. 12.

It will be appreciated that various changes and modifications can be made to the present disclosure without departing from the scope of the present application.

Although embodiments of the present v have been described in the preceding paragraphs with reference to various examples, it should be appreciated that modifications to the examples given can be made without departing from the scope of the disclosure as claimed. For example, in the illustrated embodiments, each battery cell container 104 within a battery 403 is shown as having the same length as other battery cell containers 104 in that battery 403. However, in alternative embodiments the length of one or more battery cell containers 104 within a battery may differ from the lengths of other battery cell containers 104 in that battery. This may enable the use of space available for containing the battery to be maximized.

Also, in the above described examples, the battery 403 comprises a single layer of battery cell containers 104, but in alternative embodiments the battery 403 comprises two or more layers of battery cell containers 104, one layer being positioned above another layer and each layer comprising one or more battery cell containers 104. In some such embodiments, each layer may be similarly configured to the other one or more layers, but alternatively the number of battery cell containers 104 may vary from one layer to the next layer, for example to maximize the use of space that is available for containing the battery 403. For example, a battery 403 located under the floor 405 may comprises many battery cell containers 104 in a first layer, similar to that illustrated in FIG. 5, and a second layer on top of the first layer, positioned under the seats where more space is available. In embodiments in which a vehicle 100 comprises a battery 403 under the floor 405 and a second battery 403A in, or under, the boot 1101 or a second battery 403B in the front compartment 1201, the number of layers of battery cell containers 104 in the battery 403 under the floor 405 may differ from the number of layers forming the second battery 403A or 403B. For example, a battery 403B comprising several layers of battery cell containers 104 may fit conveniently within the front compartment 1201, which contains the motor 401, while a battery 403 under the floor 405 may only comprise a single layer of battery cell containers 104.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the disclosure believed to be of particular importance it should be understood that the Applicant claims protection in respect of any patentable feature or combination of features hereinbefore referred to and/or shown in the drawings whether or not particular emphasis has been placed thereon.

The Figures show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A battery mounting arrangement for a vehicle comprising:
a first supporting structure;
a second supporting structure; and
at least one battery cell container supported by both the first supporting structure and the second supporting structure, and the at least one battery cell container having a first end face facing the first supporting structure and a second end face facing the second supporting structure;
wherein stiffness of the at least one battery cell container compared to the stiffness of the second supporting structure is sufficiently large to enable the second supporting structure to be deformed under a force provided by the at least one battery cell container due to a force applied to the first end face of the at least one battery cell container.

2. The battery mounting arrangement according to claim 1, wherein the first supporting structure extends in a first direction, the second supporting structure extends substantially parallel to the first supporting structure, and the at least one battery cell container extends in a direction from its first end face to its second end face in a second direction substantially perpendicular to the first direction.

3. The battery mounting arrangement according to claim 2, wherein the first direction is along a length of the vehicle or wherein the first direction is laterally across a width of the vehicle.

4. The battery mounting arrangement according to claim 1, wherein the stiffness of the at least one battery cell container compared to the stiffness of the first supporting structure is sufficient to enable the first supporting structure to be deformed by compression between an applied force and a reaction force provided by the at least one battery cell container.

5. The battery mounting arrangement according to claim 1, wherein stiffness of the at least one battery cell container compared to the stiffness of the first supporting structure is sufficiently large to enable the first supporting structure to be deformed under the force provided by the at least one battery cell container due to a force applied to the second end face of the at least one battery cell container.

6. The battery mounting arrangement according to claim 1, wherein the stiffness of the at least one battery cell container compared to the stiffness of the second supporting structure is sufficient to enable the second supporting structure to be deformed by compression between an applied force and a reaction force provided by the at least one battery cell container.

7. The battery mounting arrangement according to claim 1, wherein the first supporting structure comprises a first beam of the vehicle and wherein the battery mounting arrangement comprises a support plate supported by the first beam; the at least one battery cell container is mounted to the support plate; and a first portion of the support plate forms a part of the first supporting structure.

8. The battery mounting arrangement according to claim 7, wherein the second supporting structure comprises a second beam of the vehicle.

9. The battery mounting arrangement according to claim 8, wherein the support plate is supported by the second beam, and a second portion of the support plate forms a part of the second supporting structure.

10. The battery mounting arrangement according to claim 1, wherein the at least one battery cell container has a length, a height and a width; the length is longer than the height and the width; and the length is aligned laterally across the vehicle.

11. The battery mounting arrangement according to claim 1, wherein the at least one battery cell container comprises a tube and optionally wherein the tube has a rectangular cross-section.

12. The battery mounting arrangement according to claim 11, wherein the tube comprises a battery cooling pipe and/or an electrical conductor that extends from the first end face and/or the second end face of the tube.

13. The battery mounting arrangement according to claim 1, wherein the battery mounting arrangement comprises a connecting member; a lower surface of each said battery cell container is attached to a support plate; and an upper surface of each said battery cell container is fixed to the connecting member, which is configured to resist separation of each said battery cell container from a neighboring battery cell container.

14. The vehicle comprising the battery mounting arrangement of claim 1, wherein the vehicle comprises: an electric motor powered by battery cells located within the at least one battery cell container and optionally wherein the vehicle comprises a cabin for receiving users of the vehicle and the cabin has a floor defining a tunnel extending along the middle of the floor in a direction from front to rear of the vehicle.

15. A battery mounting arrangement for a vehicle comprising:
a first supporting structure extending along the vehicle;
a second supporting structure extending along the vehicle; and
a plurality of tubes aligned laterally across the vehicle, each said tube having a first end face adjacent to, and supported by, the first supporting structure and a second end face adjacent to, and supported by, the second supporting structure; and
a plurality of battery cells located in each one of the plurality of tubes.
